(19) United States
(12) Patent Application Publication
(10) Pub. No.: US 2007/0181390 A1
(43) Pub. Date: Aug. 9, 2007

(54) Air-cooled brake rotor system

(76) Inventor: Kevin Korm, Montebello, CA (US)

Correspondence Address: CISLO & THOMAS, LLP, 233 WILSHIRE BLVD, SUITE 900, SANTA MONICA, CA, 90401-1211, US

(21) Appl. No.: 11/350,531

(22) Filed: Feb. 8, 2006

(51) Int. Cl. F16D 65/12

(52) U.S. Cl. 188/218 XL

(57) ABSTRACT

An air-cooled brake rotor system defining an inter-rotor disk slot through which spacers in the form of turbine or fan vanes propel air when the brake rotor system is turned. An inner disk brake rotor plate is attached to a hub which in turn may be attached to an axle on a vehicle such as an automobile. Pins having ends of opposite threading are used to connect the inner rotor to the outer rotor. The outer rotor is spaced apart from the inner rotor by means of spacers which are shaped to propel air through the slots defined between the two rotors. The spacers are also configured so that compression of the two rotors by a caliper system always serves to have a spacer beneath the area engaged by the brake pad to provide mechanical support for the rotor system. Each rotor generally has defined in it venting holes and inscribed debris-channeling slots in an arcuate, volute, or turbinate manner. An enhanced braking system experiencing lower heat retention is thereby attained.

### COPYRIGHT AUTHORIZATION

Portions of the disclosure of this patent document may contain material which is subject to copyright and/or mask work protection. The copyright and/or mask work owner has no objection to the facsimile reproduction by anyone of the patent document or the patent disclosure, as it appears in the Patent and Trademark Office patent file or records, but otherwise reserves all copyright and/or mask work rights whatsoever.

### BACKGROUND OF THE INVENTION

1. Field of the Invention

This invention relates to brakes, and more particularly to disk brakes for automotive and or other vehicles or the like that uses a pair of co-axial rotor planes that are particularly designed for rapid cooling by ambient air.

2. Description of the Related Art

Brakes are well known in the art and are often used with a variety of vehicles including locomotives, automobiles, trucks, jet aircraft landing gear, bicycles, and the like. Particularly, disk brakes have become increasingly used due to their ability to provide good braking and, possibly, they are better than and/or are easier to service than drum brakes.

In general, brakes are mechanical devices by which forward motion of a vehicle is transferred into heat via friction. For disk brakes, a disk or disks are generally coupled to the turning wheel which may be one of several providing locomotion for the associated vehicle. The brake shoes are generally attached to the vehicle or its chassis such that when the brake pads are applied on either side of the disk or disks, friction (preferably high friction for quick stopping) arises between the disk brake rotor and the brake pad.

For vehicles with large momentum, or for small brakes relative to the vehicle momentum, a large amount of heat can be quickly generated. As a result, asbestos has been used in the past in certain brake elements.

From the above, it stands to reason, that if brake parts could be cooled quickly, they could withstand greater force and friction, would become more reliable, and would provide better braking.

Prior attempts have been made in the art with respect to brake rotor systems and otherwise. Brief descriptions of some of such prior attempts are set forth below. While the descriptions are believed to be accurate, no admission is made by them regarding their subject matter which is solely defined by the patent or reference involved.

U.S. Pat. No. 6,334,515 B1 issued to Martin is directed to a brake disk for disk brakes of vehicles made of a material of the carbon group where the brake disk is formed as a ventilated brake disk made up of two individual friction rings which are undetachably connected with one another. The two friction rings are connected with one another by way of pins which have a thickened center part and end parts which are set off thereto. The end parts are fitted into respective bores in the friction rings.

U.S. Pat. No. 4,132,294 issued to Poli is directed to a brake disk assembly having a hub provided with a circumferential radial flange structure extending therefrom and having front and rear annular faces, at least two sector shaped lining parts which together form an annular assembly, each part being of monolithic construction and including confronting front and rear sector-shaped linings, all of the linings together forming front and rear annular linings the outer surfaces of which will be acted on by braking jaws during use of the assembly, each of the parts being removably fitted over the flange structure in concentric relationship with the hub so that the front and rear faces of the flange structure lie between the opposed surfaces of the confronting front and rear sector-shaped linings, the linings having radially extending inner ribs projecting therefrom so as to form cooling passages open at both their radial inner and outer ends, at least some of the ribs having edges which serve as guides for the lining parts during fitting of the latter over the flange in a radial direction, the rib edges engaging the flange structure in the completed brake disk assembly; and for each sector-shaped lining part a single removable connecting element extending parallel to the axis of the hub and connecting the respective lining part with the flange structure, each of the connecting elements being located approximately at the center of the respective lining part.

U.S. Pat. No. 4,043,437 issued to Taylor is directed to a torque limiting brake for a heavy duty automotive clutch. The brake, which is keyed to the driven shaft, is engaged by the release mechanism when the clutch is disengaged and moved into engagement with an adjacent stationary surface. This operates to stop the rotation of the driven shaft which tends to continue rotating due to inertia. To prevent damage to the brake when excessive braking pressure is applied, a yieldable connection is provided between the brake inner portion that is keyed to the driven shaft and its outer portion that engages the stationary surface whereby the former can have limited rotation relative to the latter if the braking pressure exceeds a predetermined amount.

U.S. Pat. No. 6,216,829 B1 issued to Daudi is directed to a vented brake rotor having tubular ducts. The rotor includes universal rotor blank having a hat section and a peripheral section radially extending therefrom. The hat section includes a mounting face and hat wall extending from the periphery of the mounting face. The peripheral section includes a first and a second braking plate joined together in a parallel, spaced apart relationship by a plurality of spacers. A plurality of duct tubes are fastened to the inner surfaces of the braking plates. Each one of the duct tubes has an inlet and an outlet allowing air to flow through the duct tube to provide an airflow path between the braking plates for cooling the rotor. In an alternate embodiment, the present invention may include a plurality of fins fastened to the inner surfaces of the braking plates. The fins extend between the braking plates forming a passages between them. A plurality of duct tubes are fastened in the passages between the fins.

U.S. Patent Application Publication No. 2004/0200678 A1 of Lin is directed to a brake rotor and methods for cooling and/or removing debris from a brake rotor. The brake rotor may include a first and second annular braking surfaces jointly has inner and outer circumferential surfaces and a central portion and a hat portion disposed in the central portion and adapted for mounting the rotor to a vehicle. The rotor may also include a plurality of vanes provided between the inner and outer circumferential surfaces, which may define a plurality of corresponding flow channels between at least a pair of vanes. Each flow channel may include a first flow channel opening (e.g., inlet) provided near the central region and a second flow channel opening (e.g., outlet) provided near a periphery of the brake rotor. The rotor and methods also may include a plurality of first slots provided on the first annular braking surface and a plurality of second slots provided on the second annular braking surface corresponding to the plurality of first slots. At least one first opening may be included within one or more slots. Similarly, at least one second opening may be provided within each second slot. Each second opening of each second slot may correspond substantially to and fluid communicate with a first opening of a first slot.

U.S. Pat. No. 2,708,492 issued to Helsten is directed to brake rotors and more particularly to a novel rotor adapted for use in railway brake equipment wherein high speeds result in the development of intense heat on the friction surfaces of the rotor.

U.S. Pat. No. 3,425,524 issued to Dewar is directed to a brake stator constituted by a metal shell having an internal core of high specific heat material such as beryllium, the braking surfaces being provided by the shell and the braking heat being absorbed by the core material which is adapted to be a thermal reservoir and is of light weight properties.

U.S. Pat. No. 4,286,694 issued to Wiseman, Jr. et al. is directed to brake disks of carbon or other porous material in which the opposed faces of the disks are provided with shallow grooves extending between the inner and outer circumferences to vent steam and other gases generated during braking. The grooves of the stationary disks may be at different angles relative to the radii than are the grooves of the rotating disks.

U.S. Pat. No. 6,446,770 B2 issued to Qian et al. is directed to a rotor that has an array of grooves formed on the brake pad contact surface. The array is preferably formed as a repeating pattern of regularly spaced grooves. The repeating pattern of grooves creates a plurality of radially and circumferentially offset rings of grooves. The rings can radially overlap. The rotor is preferably ventilated having two brake pad contact surfaces separated by a plurality of vanes. The grooves are preferably arranged on the brake pad contact surfaces between the vanes. The grooves can have various configurations and shapes. The array of grooves increases friction between a brake rotor and brake pads, and decreases the thermal gradient and thermal distortion on the brake pad contact surfaces.

U.S. Pat. No. 3,899,054 issued to Huntress et al. is directed to a disk brake structure which includes a rotor presenting two spaced walls with a plurality of rods connected to the interior surfaces thereof so that air passing from the center of the rotor between the interior surfaces of the rotor walls and outward from the rotor is constrained to follow a substantially tortuous path.

U.S. Pat. No. 5,429,214 issued to Wiebelhaus et al. is directed to a ventilated brake disk for rail vehicles of a divided or undivided design is provided. The brake disk comprises a brake ring with ribs connected to the hub. Projections for fastening the brake ring to the hub are connected to selected ribs having recesses. In another design the brake ring, within its neutral range, is provided with projections arranged opposite one another at a dividing groove, each projection having a respective tangential bore for receiving a screw for fastening the sections of the divided brake ring, whereby a portion of the ribs in the area of the projections extends radially inwardly and radially outwardly from the projections. In another design first projections have respective first tangential bores aligned with one another for receiving a first screw are positioned opposite one another at a dividing groove of the brake ring in the vicinity of its inner circumference. Second projections have second tangential bores aligned with one another for receiving a second screw and are positioned opposite one another at the dividing groove of the brake ring in the vicinity of its outer circumference, whereby a portion of the ribs in the area of the first and second projections extends in a radial direction between the first and second projection to a maximum possible length. With these designs an improvement of the cooling air flow is achieved due to the generation of a transverse flow.

U.S. Patent Application Publication No. 2004/0195059 A1 of Williams is directed to mounting system for disk brake rotors. Drive pins are mounted to a wheel hub. Alignment bushings having outer flanges has a channel are slidably held in slots in a disk brake rotor, with the rotor engaging the bushing channel. The alignment bushings are each mounted on a drive pin inserted through a hole in the alignment bushing. Drag rings prevent unwanted movement between the alignment bushings and the drive pins. The drag rings can be mounted in grooves in the alignment bushings or, alternatively, in grooves on the drive pins. Retaining rings on the drive pins prevent the bushings from coming off of the drive pins.

U.S. Patent Application Publication No. 2004/0226786 A1 of Shamine et al. is directed to a rotor having a disk and a hub assembly, in which the disk may be easily removed from the hub. The assembly has driving pins to connect the disk with the hub. The driving pins take up the tolerance between the disk and hub connection and absorb the torque applied to the rotor, preventing stress and therefore fatigue on the disk and hub.

European Patent Application Publication No. 0 289 176 A2 of Colgate is directed to a braking member for a vehicle disk brake comprising of at least one metal plate of a generally annular outline. The plate is provided with angularly spaced recesses or slots which extend inwardly from the peripheral edge of the plate and define passages for the passage of air and/or liquid to increase the cooling of adjacent friction linings when the plate is installed in a brake and the brake is applied. The passages may be defined between two superimposed similar plates or the plate may be sandwiched between two planar plates.

International Patent Application Publication No. WO 2004/060732 A1 of Santilli is directed to an improvement introduced for a disk brake system for automotive vehicles characterized by a system comprising a combined arrangement of a fixed brake rotor and at lease one axial sliding brake rotor supplemental friction pads between the brake rotors and the braking force being applied by a single caliper. The brake rotors can be of the solid disk type or the slotted internal air-cooled disk type.

### SUMMARY OF THE INVENTION

In view of the foregoing disadvantages inherent in the known types of brake systems now present in the prior art, the present invention provides a new air-cooled brake rotor system wherein the same can be used to provide a braking system as it increases the ventilation and heat dispersion for cooler operation.

The general purpose of the present invention, which will be described subsequently in greater detail, is to provide a new and cooler-operating brake rotor system which has many of the advantages of the brake systems mentioned heretofore as well as many novel features that result in a new brake rotor system which is not anticipated, rendered obvious, suggested, taught, or even implied by any of the prior art brakes, either alone or in any combination thereof.

In the foregoing references, no disclosure is made of an air-cooled braking system having the structure and operation of that as set forth in more detail below. The construction, assembly, and operation of the air-cooled brake rotor system set forth herein provides greater cooling and better operation in a manner that allows easy replacement of the rotors by their easy disengagement from the hub. Furthermore, the attachment means by which the inner and outer rotors are coupled possibly enhances both safety and operation.

A central hub is provided in the present invention to which an inner rotor is attached as by screws, bolts, threaded pins, other threaded members, or otherwise. To this inner rotor, an outer rotor may be attached by threaded pins. The inner and outer rotors are spaced apart by spacers which simultaneously act as vanes or propeller elements for urging or forcing air through the gap present between the inner and outer brake disk rotors.

In order to attach the inner and outer rotors, a unique pin system is used that enables the two co-axial rotors to be pulled together even though each of the threaded pin members is turned in the same direction. To accomplish this, each of the threaded pins is cut with threads in two different directions at each of the two ends. Correspondingly, the same threading as is appropriate is cut into apertures in both the inner and outer rotor disks in a corresponding fashion. In this way, each threaded pin has. an end threaded for the inner rotor with the opposite end threaded for the outer rotor. Using a special tool (described in more detail below) or otherwise, turning the threaded pin in a certain direction, such as clockwise, serves to thread the pin simultaneously into both the inner and outer rotor. This pulls the two rotors together until they are stopped by the spacer which is compressed in order to provide a snug friction fit between the two rotors and the spacer.

The threaded pins are generally made of material that is softer than either of the two inner or outer rotor disks. The threaded pins generally project past the threaded apertures in both the inner and outer rotor and these projecting stubs are then cut off and generally deformed in order to conform to the outer surface of the brake rotor plates and to prevent turning of the threaded pins during operation of the rotor system.

The spacers are generally arcuate parallelepipeds and are generally parallel to one another in the sense that they do not intersect and generally define the same curved chord geometrically across the annular inner surfaces of the inner and outer rotor disk plates. The curved nature of the spacers allow them to operate as propeller or fan blades in order to propel air through the inter-disk space when the brake rotor system is turned as then the wheel to which it is attached turns.

Each of the brake rotor disks is drilled with a series of ventilation holes to increase the surface area and airflow through the rotor disk plate. The rotor disks are inscribed with slots for the collection and dispersion of debris such as brake pad dust.

By the assembly and convergence in the various mechanical devices and technologies available, the brake disk rotor system of the present invention provides a new approach to braking in a robust manner that enables cooler operation of the brake rotor in a manner that generally operates according to the speed of the vehicle involved. For example, if the vehicle is traveling fast, more air is propelled through the inter-disk space by the spacers, and more cooling occurs for the brake rotor system than when the vehicle is traveling more slowly. The increased surface area provided by the ventilation holes enables better radiation into the air adjacent and flowing past and through such holes in order to enable and promote cooling. Each of the inscribed features in each of the brake disk rotor plates is generally parallel to one another (even though they are curved) in that they do not intersect across the face of the brake rotor disk plate. Consequently, the inscribed slots with its two sets of ventilation holes on either side of each inscribed slot as well as the threaded apertures used for coupling the disks to one another generally enjoy the same curved relationship with respect to each other and disposition with respect to the associated disk plate. These features are generally paired with similar features on the opposite side of the other disk plate and the direction of these features is dependent upon which side of the vehicle (left or right) on which the brake rotor system is placed. Generally, the features set forth above with respect to the disk rotor plates are lead by the inner circumference features and trailed by the outer circumference features. For example, with respect to the inscribed slot, the leading edge of the slot is generally present at the interior circumference of the disk brake rotor annulus when the vehicle travels forward. As a result, left and right side brake rotor systems as constructed herein are generally mirror images of one another.

In one embodiment, a brake rotor has a hub, an inner rotor coupled to the hub, and an outer rotor coupled to the inner rotor. A spacer serves to separate the inner rotor from the outer rotor.

In another embodiment, a brake rotor has a hub having a first radial extension having an outer surface. An inner rotor is detachably coupled to the hub with the inner rotor having a second radial extension for detachably coupling the inner rotor to the first radial extension of the hub. The inner rotor has a first vent hole that allows fluid flow through the first vent hole, has a first slot inscribed on an outer surface of the inner rotor that channels and urges debris away from the inner rotor, and has a first threaded attachment hole for threadably coupling the outer rotor to the inner rotor, the first threaded attachment hole threaded in a first threaded direction.

An outer rotor is coupled to the inner rotor with the outer rotor initially attached to the inner rotor in a detachably attached manner. The outer rotor has an inner diameter engaging the outer surface of the first radial extension of the hub. The outer rotor has a second vent hole allowing fluid flow through the second vent hole, has a second slot inscribed on an outer surface of the outer rotor that channels and urges debris away from the outer rotor, and has a second threaded attachment hole for threadably coupling the outer rotor to the inner rotor, the second threaded attachment hole threaded in a second threaded direction.

The first vent hole, first slot, and the first threaded attachment hole of the inner rotor are generally oppositely opposed the second vent hole, second slot, and the second threaded attachment hole of the outer rotor.

A spacer separates the inner rotor from the outer rotor, the spacer shaped to act as a turbine vane so that air is driven through a space defined between the inner and outer rotors when the brake rotor turns. The spacer has a spacer hole and the spacer is initially coupled in an oblique manner to the inner and outer rotors in a detachably attached manner.

A threaded pin couples the inner rotor to the outer rotor. The threaded pin is softer than the inner rotor and the outer rotor and passes through the spacer hole. The threaded pin has first and second opposite ends with the first end being threaded in the first threaded direction and the second end being threaded in the second threaded direction. The first end of the threaded pin engages the first threaded attachment hole and the second end of the threaded pin engages the second threaded attachment hole. The first and second threaded directions are such that turning the threaded pin in a first circular direction urges the inner and outer rotors together and turning the threaded pin in a second circular direction urges the inner and outer rotors apart.

In another embodiment of the present invention, a braking disk system in a brake rotor system having a hub has an inner rotor, an outer rotor coupled to the inner rotor, and a spacer separating the inner rotor from the outer rotor.

A further embodiment of the. present invention has a braking disk system in a brake rotor system having a hub with the braking disk system including an inner rotor detachably attachable coupled to the hub, the inner rotor having a first radial extension for detachably coupling the inner rotor to the hub. The inner rotor has a first vent hole allowing fluid flow through the first vent hole and the inner rotor. The inner rotor has a first slot inscribed on an outer surface of the inner rotor which may channel and disperse debris (such as brake pad dust) away from the inner rotor. The inner rotor has a first threaded attachment hole for threadably coupling the outer rotor to the inner rotor, the first threaded attachment hole threaded in a first threaded direction.

An outer rotor is coupled to the inner rotor with the outer rotor initially attached to the inner rotor in a detachably attached manner. The outer rotor has an inner diameter engaging an outer surface of the hub. The outer rotor has a second vent hole allowing fluid flow through the second vent hole and the outer rotor. The outer rotor has a second slot inscribed on an outer surface of the outer rotor, the second slot channeling and urging debris away from the outer rotor. The outer rotor has a second threaded attachment hole for threadably coupling the outer rotor to the inner rotor. The second threaded attachment hole is threaded in a second threaded direction. The first vent hole, the first slot, and the first threaded attachment hole of the inner rotor are oppositely opposed to the second vent hole, the second slot, and the second threaded attachment hole of the outer rotor such that the features on the inner rotor are mirrored by the corresponding ones on the outer rotor.

A spacer separates the inner rotor from the outer rotor. The spacer is shaped to act as a turbine vane so that air is driven through the space between the inner and outer rotors when the brake rotor turns. The spacer has a spacer hole and is coupled in an oblique manner to the inner and outer rotors in an initially detachably attached manner.

A threaded pin couples the inner rotor to the outer rotor. The threaded pin is softer than the inner rotor and the outer rotor so that the threaded pin does not wear upon (and make a groove in) the corresponding brake pad. The threaded pin passes through the spacer hole and has first and second opposite ends with the first end threaded in the first threaded direction and the second end threaded in the second threaded direction so that the threaded pin can engage both the inner and outer rotors. The first end of the threaded pin engages the first threaded attachment hole and the second end of the threaded pin engages the second threaded attachment hole. The first and second threaded directions are such that turning the threaded pin in a first circular direction (such as clockwise) urges the inner and outer rotors together and turning the threaded pin in a second circular direction (such as counterclockwise) urges the inner and outer rotors apart.

In another embodiment, the present invention provides a brake rotor disk for a brake rotor system having a hub, the brake rotor disk having braking disk adapted for coupling to the hub. The braking disk has a first vent hole allowing fluid flow through the first vent hole, a first slot inscribed on an outer surface for channeling and urging debris away from the braking disk, and a first threaded attachment hole threaded in a first threaded direction and adapted to receive a threaded pin.

Another embodiment of the present invention provides a spacer for a brake rotor system having two oppositely opposed coaxial brake rotor disks. The spacer has an arcuate parallel piped shape and is made of resilient material. The spacer has two generally flat sides adapted for engagement with interior surfaces of the brake rotor disks at an oblique angle with respect to a radius of the brake rotor disks. The arcuate parallelepiped spacer has a top side, a bottom side, a front side, and a rear side with the top side curved to conform with an outer perimeter of the brake rotor disks. The bottom side is curved to conform with an inner perimeter of the brake rotor disks. With the top and bottom sides so curved, the spacer conforms to the geometry of the coaxial brake rotor disks.

Another embodiment of the present invention provides a method for making a braking disk system in a brake rotor system that has a hub. The steps in the method include providing a first annular braking plate, forming a first air vent hole therein, inscribing a first slot on an outer surface of the first annular braking plate, and forming a first threaded attachment hole in the first annular braking plate with the first threaded attachment hole threaded in a first direction.

Other embodiments are set forth in more detail, below.

### OBJECTS OF THE INVENTION

It is an object of the present invention to provide a better disk braking system by providing a co-axial dual rotor system that is more readily cooled by ambient air.

It is another object of the present invention to provide an air-cooled disk brake rotor system.

It is yet another object of the present invention to provide an air-cooled disk brake rotor system that is reliable, durable, and that promotes its own cooling when the wheel associated with the rotor system turns.

These and other objects and advantages of the present invention will be apparent from a review of the following specification and accompanying drawings. The foregoing objects are some of but a few of the goals sought to be attained by the present invention and are set forth for the purpose of example only and not those of limitation.

### BRIEF DESCRIPTION OF THE DRAWINGS

FIG. 1 is a left front perspective view of an air-cooled brake rotor system according to the present invention intended for the left side of a vehicle.

FIG. 2 is a side and exploded view of the air-cooled brake rotor system of FIG. 1 showing the various constituents and connecting elements.

FIG. 3 is a front left side and perspective view of the outer rotor of the air-cooled brake rotor system of FIG. 1.

FIG. 4 is a front left side and perspective view of the inside surface of the inner rotor of the air-cooled brake rotor system of FIG. 1. The exterior side of the inner rotor generally being inscribed in a manner shown in FIG. 3. The inner side of the outer rotor shown in FIG. 3 generally being somewhat similar to that shown in FIG. 4.

FIG. 5 is a side cross-sectional view of the connecting pin system as taken along line 5-5 of FIG. 1.

FIG. 6 is a side cross-sectional view of the inscribed slot generally taken along the line 6-6 of FIG. 1.

### DESCRIPTION OF THE PREFERRED EMBODIMENT(S)

The detailed description set forth below in connection with the appended drawings is intended as a description of presently-preferred embodiments of the invention and is not intended to represent the only forms in which the present invention may be constructed and/or utilized. The description sets forth the functions and the sequence of steps for constructing and operating the invention in connection with the illustrated embodiments. However, it is to be understood that the same or equivalent functions and sequences may be accomplished by different embodiments that are also intended to be encompassed within the spirit and scope of the invention.

The present invention resides in an air-cooled brake rotor system having venting holes, inscribed slots, and spacers working in tandem in a co-axial dual plate rotor system to provide better braking and better cooling of the disk elements in a disk brake system. A central hub may be detachably attached to an inner rotor to which an outer rotor is attached by threaded pins. The distance between the inner and outer rotors as dictated by a spacer that is generally formed in a shape of a turbine vane or otherwise. Spacers are generally equally spaced about the circumference of the rotor system and serve to urge air between the two rotor plates when the rotor turns as by travel of the associated vehicle.

Additional cooling arises from the use of vent holes present between the spacers and generally aligned to the spacers. Further, an inscribed slot helps to channel and disperse debris, such as brake pad dust, that arises during the use of the brakes as when the brake pads are applied to the brake rotors. Separately, and in combination, the various elements of the air-cooled brake rotor system of the present invention provide robust means for vehicle braking while supplying the additional advantage of promoting cooling of the active elements involved, particularly the brake disk rotors.

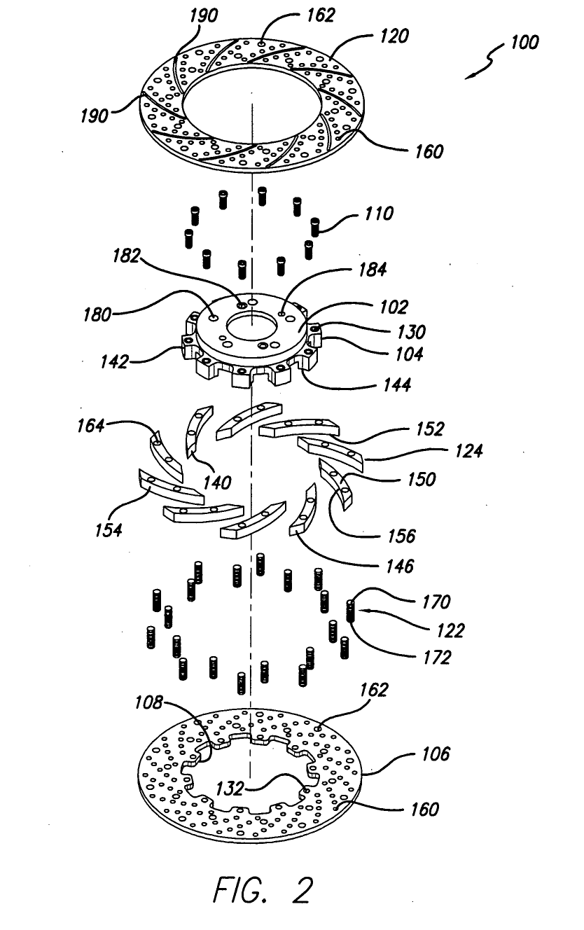

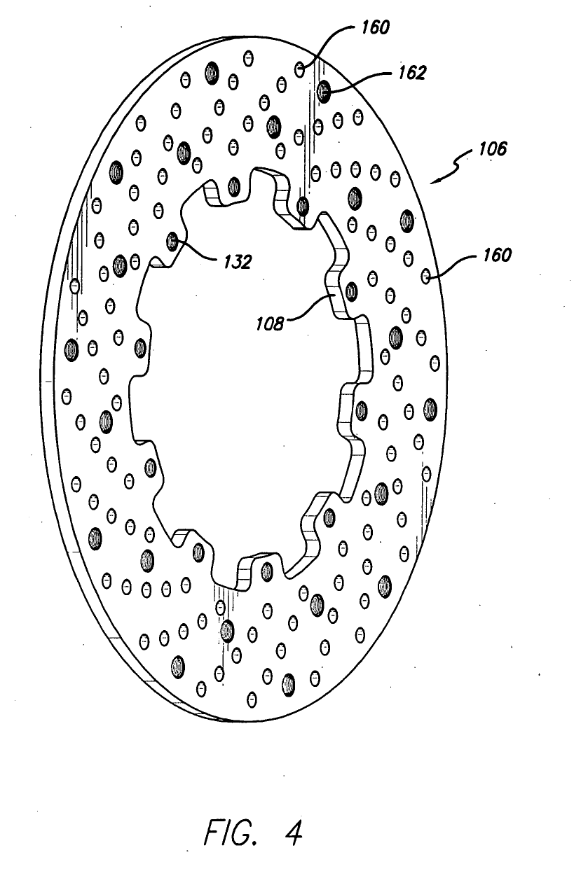

Referring to the drawings, where like numerals of reference designate like elements throughout, it will be noted that the air-cooled brake rotor system 100 has several different elements, including a hub 102 having extensions 104. The inner rotor 106 has inner extensions 108 (FIGS. 2, 4) enabling the attachment of the inner rotor 106 to the hub 102 via threaded hub members 110.

The outer rotor 120 is coupled or connected to the inner rotor 106 by means of threaded pins 122 which pass through spacers 124. The threaded pins hold the inner and outer rotors 106, 120 together as well as securing the spacers 124 in place. Generally, threaded pins 122 are made of softer material so that the threaded pins 122 wear out faster than the rotors 106, 120 so that the threaded pins 122 do not inscribe or etch grooves into the brake pads (not shown).

When fully assembled, the air-cooled brake rotor system of the present invention is then mountable upon an axle such as that on an automobile or the like. Brake pads may be set into place in order to engage the brake rotor system 100 on the outer and exposed surfaces of the inner and outer rotors 106, 120. As set forth in more detail below, both the inner and outer 20 rotors 106, 120 are fabricated and constructed in a manner to promote cooling and to coordinate their structure with the air-propelling spacers 124 which are also described in further detail below.

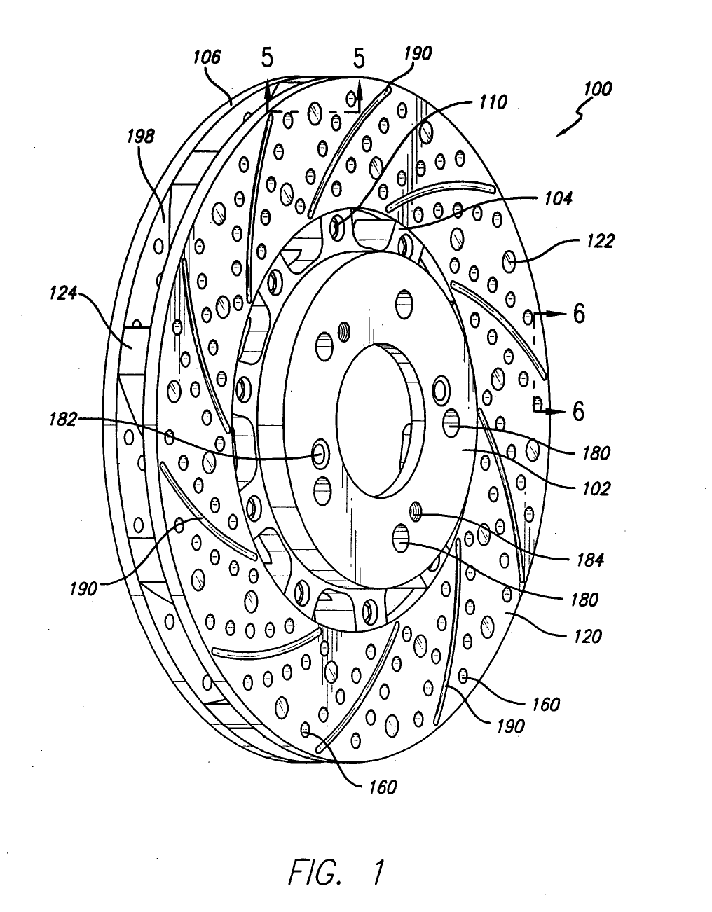

FIG. 2 shows an exploded view of the brake rotor system 100 of FIG. 1.

Hub 102 is connected to inner rotor 106 by means of threaded hub members 110. Threaded hub members 110 pass through threaded hub holes 130 present in the hub extensions 104 of the hub 102. The threaded hub holes 130 correspond to inner rotor hub connection holes 132 that correspond to and align with the threaded hub holes 130 of the hub 102. The threaded hub members 110 may take a variety of embodiments and threading may not necessarily be required in order to connect the hub 102 to the inner rotor 106. However, as shown in the Figures, the threaded hub members 110 generally take the form of bolts having hexnut heads that enable removable engagement of the inner rotor and the associated disk rotor assembly from the hub. In this way, the hub 102 can be preserved while the inner. and outer rotors 106, 120 may be replaced by the disengagement of the inner rotor 106 from the hub 102.

The inner rotor 106 may be connected to the hub 102 by the threaded hub members 110 either prior to or after the further assembly and connection of the outer rotor 120 and the spacers 124 to the inner rotor 106.

In order to construct the dual and co-axial brake rotor assembly which has the inner rotor 106, outer rotor 120, and spacers 124 assembled into a rotor assembly, in one embodiment, the threaded pins 122 that interconnect the inner and outer rotors 106, 120 may be slightly threaded into one of the rotors 106, 120. The provides some stability to the threaded pins 122 and the spacers 124 may then be placed upon the spacers 122.

The spacers 124 are generally formed in the manner of a turbine vane with the inner ends 140 generally conforming to the inner diameter of the brake rotor system and more particularly the outer end 142 of the hub extensions 104. In one embodiment, the spacers 124 may somewhat be considered extensions of the hub extensions as the inner spacer ends 140 are in close proximity to and generally in registration with the hub extensions 104.

At this point, note should be taken that the hub extensions 104 (as shown in FIG. 2) generally extend somewhat below and project down from the hub 102. This gives rise to a certain downward extension 144 of the hub extension 104 and provides some clearance from the solid interior of the hub 102 which is generally formed in a manner that projects upwardly and away from the hub extensions 104. As shown in FIG. 2, the center portion of the hub 102 generally projects somewhat upwardly and away from the plane of the extensions 104. This is of note as it generally leaves the area between the hub extensions open and allows the free flow of air thereto, such air being channeled (when the rotor system 100 rotates or turns) between the two rotor plates 106, 120. This disposition between the hub extensions 104 and the hub 102 also enables the inner and outer disk rotor plates 106, 120 to be situated closer to the axle and away from the wheel which is generally attached to the same axle in a co-axial manner as the brake rotor system 100.

The outer end 146 of the spacer 124 is generally formed to conform to the outer circumference of the brake rotor system 100 which generally coincides with the outer circumferences of both the inner and outer rotors 106, 120. Conformance of the inner and outer ends 140, 146 of the spacer 124 generally lends to a more streamlined effect and may diminish turbulent air flow between the two rotor plates 106, 120.

The spacer 124 may have top and bottom sides 150, 152 which respectively engage the inner surfaces of the outer rotor 120 and inner rotor 106. These surfaces 150, 152 are generally defined by the shape or topography of the inner surfaces of the rotors 106, 120. As a result, these surfaces are generally flat to a high degree in order to assure good and continuous engagement between the adjacent surfaces of the rotors 106, 120 and the spacers 124.

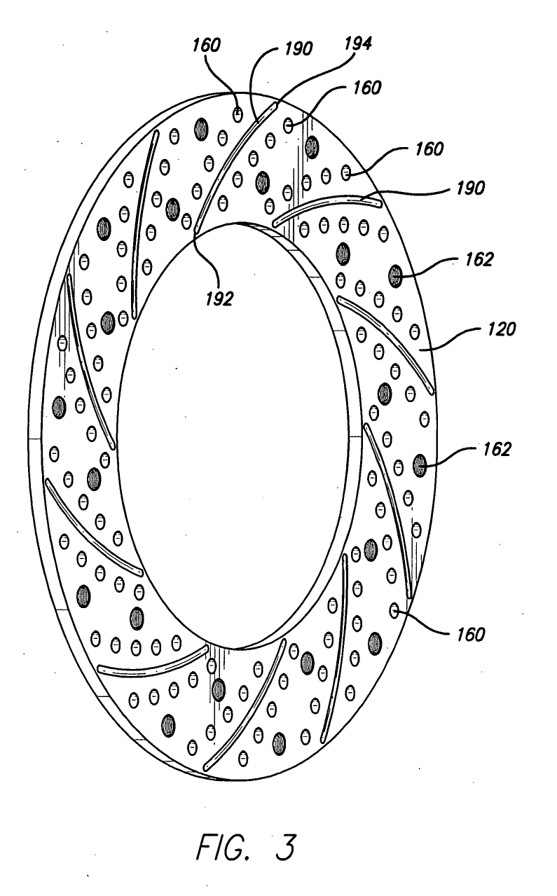

As shown in FIG. 2, the air-cooled brake rotor system 100 is formed to generally turn in a counterclockwise fashion due to the directionality of the inscribed features. These features and their directionality are set forth in more detail below with respect to the disclosure and description regarding FIGS. 3 and 4. This directionality may lead to the specific geometry of the forward or leading surface 154 of the spacer 124 as well as the trailing surface 156. As the brake rotor system 100 spins or turns along its co-axial axis shared by the rotors 106, 120 and the hub 102, the forward surfaces 154 of the spacers 124 tend to push the air outwardly and away from the center of the system. The propelled air generally creates an area of lower pressure behind it that serves to draw in additional air. This additionally drawn-in air is generally cooler than the evacuated air which has been exposed to the possibly hot surfaces of the rotor 106, 120. Similarly, the trailing surfaces 156 of the spacers 124 tend to pull air in by creating an area of lower air pressure behind them when the brake rotor system 100 turns.

Further venting and cooling of the rotors 106, 120 by the newly drawn-in air may rapidly occur. The rotors 106, 120 are then cooled and the spacers 124, particularly the leading surfaces 154 thereof, serve to urge additional air out of the area proximate with the rotors 106, 120 establishing a cooling cycle that is driven by the turning of the brake rotor system 100. The trailing surfaces 156 of the spacers 124 may also lend themselves to the evacuation of such air. As shown in FIG. 2, the forward and trailing surfaces 154, 156, of the spacer 124 are generally curved in a manner consistent with the etched features of the rotor plates 106, 120 and may be generally be in an angle on the order of 15 degrees to 60 degrees with respect to a radius from the co-axial center of the brake rotor system 100.

As set forth in more detail below, the exposed apertures or venting holes 160 of the inner and outer rotors 106, 120 may serve as conduits for such cooling air driven by the spacers 124.

The outer rotor 120 has rotor attachment holes 162 that correspond to rotor attachment holes 162 in the inner rotor 106. As shown in FIG. 2, pairs of rotor attachment holes 462 correspond to spacer through-holes 164. The spacers 124 are generally as thin as possible to allow the greatest passage of air past the spacers and between the inner and outer rotors 106, 120. However, the spacers 124 must be thick enough and wide enough to provide structural integrity to the air-cooled brake rotor system 100 as a Whole. Furthermore, the threaded pins 122 must be of a substantial nature and the spacer through-holes 164 must be slightly larger than the threaded pins 122 to provide for easy assembly. The spacers 124 depend upon their fixation with respect to the inner and outer rotors 106, 120 from the threaded pins 122.

When the spacers 124 are placed upon the threaded pins-122 and the threaded pins 122 project through the spacers 124, the outer rotor 120 may be placed in position to engage the exposed tops of the pins 122 with its threaded rotor attachment holes 162. The dual plate brake rotor assembly is then ready to be set into place by the threading and turning of each of the threaded pins 122 into both the inner rotor 106 and the outer rotor 120.

In a particularly efficient fashion, the inner and outer rotors 106, 120 are brought together to compress the spacers 124 simultaneously by the turning of the threaded pins 122 in a single direction (generally either clockwise or counterclockwise). This occurs in the following way. Each threaded pin 122 has a top end 170 and a bottom end 172 which are each threaded in an opposite direction. Due to this opposite threading at opposite ends 170, 172 of the threaded pin 122, when the threaded pin 122 is turned to be threaded into either one of the two rotors, the threaded pin 122 simultaneously threads into the other rotor.

This demands that each of the rotors 106, 120 have rotor attachment holes that are also threaded in opposite directions. For example, all of the rotor attachment holes 162 of the outer rotor 120 may be threaded in a right hand direction while all of the rotor attachment; holes 162 of the inner rotor 106 may be threaded in a left handed direction. The upper end 170 of the pin 122 may also be threaded in a right hand direction while the lower end 172 may be threaded in a left hand direction.

When this configuration is achieved, if the pin 122 is turned in a counterclockwise direction, it will simultaneously thread itself into the outer rotor 120 and the inner rotor 106. This can be seen by taking one's hands and curling the fingers of the right hand and pointing the thumb of the right hand upwardly and curling the fingers of the left hand the curling the thumb of the left hand downwardly. It will be observed that the fingers of each hand are going in the same counterclockwise direction. This is not the case when the two people engage both of their right hands in a similar manner. Their fingers will go in opposite directions, one going counterclockwise and one going clockwise.

Consequently, by initially temporarily securing the bi-threaded pins 122 in the inner rotor 106 (for example, arranging the spacers 124 on the upstanding pins 122 and then starting the threading of the pins 122 in the rotor attachment holes 162 of the outer rotor 120) the additional turning of each of the threaded pins 122 serves to simultaneously thread them into the rotor attachment holes 162 of both the outer rotor 120 and the inner rotor 106.

The slight offset that may occur during the initial threading stage is generally accommodated by the width of the spacer 124. One or both ends of the bi-threaded pins 122 may be specially configured for engagement by a screwdriver, special tool, or otherwise and the bi-threaded pins 122 are generally slightly longer than the necessary length with the two rotor plates 106, 120 to securely, firmly, and snugly compress and engage the spacers 124.

By using bi-threaded pins 122 of a length that is longer than necessary, the outer surfaces of the rotors 106, 120 may then be able to machined flat, removing the excess length of the bi-threaded pins 120 and generally deforming the ends of the pins 122 so that they form a close engagement with each of the rotors 106, 120.

In one embodiment, a special tool (in the form of a jig or otherwise) may be used to rapidly perform the assembly of the dual rotor plate and spacer assembly. However, although it may take additional time and effort, the securement of the inner and outer rotor plates 106, 120 to each other by means of the bi-threaded pins 122 could be performed by hand as by a screwdriver, wrench, or otherwise and it is currently contemplated that this manual process is one that could be automated by the special tool which could thread the pins 122 simultaneously or iteratively (one by one in small increments).

As the bi-threaded pins 122 are turned to thread into both the inner and outer rotors 106, 120, the two rotors approach each other until met by the top and bottom sides 150, 152 of the spacers 124. The bi-threaded pins 122 are turned and tightened as far as possible in order to secure the two rotor plates 106, 120 together as securely as possible. The finishing step of the removal of the bi-threaded pin ends 170, 172 to make the outer surfaces of the rotors 106, 120 flat generally serves to secure the outer rotor 120 to the inner rotor 106 with the spacers 124 securely fixed in between.

As shown in FIGS. 1 and 2, the hub 102 may have a set of apertures for a variety of purposes. Hub through-holes 180 may be provided to enable threaded projections to project therethrough so that a tire with its wheel may be attached to the axle shared with the brake rotor system. Additional holes 182 may be used for attaching of the hub 102 and the entire brake rotor system 100 to the axle. Threaded hub through-holes 184 may be used to attach items to the hub 102 or to attach the hub 102 to the axle or otherwise.

FIG. 3 shows the outer face of the outer rotor 120. The features shown on the outer face of the outer rotor 120 are generally the same for both the outer rotor 120 and the inner rotor 106. These features in the form of venting holes 160, rotor attachment holes 162, and inscribed slots 190 serve to either affect attachment of the rotor with other members (as for the rotor attachment holes 162), provide ventilation (as in the ventilation holes 160), or provide means by which debris can be channeled and dispersed from the outer surface of the associated rotor (such as by the inscribed slots 190 which serve to disperse brake pad dust).

Generally, due to the alignment necessary between the opposite pairs of rotor attachment holes 162 for the inner and outer rotors 106, 120, the outer rotor surfaces may be generally mirror images of one another. As can be seen in FIGS. 1-4, these features are generally arranged in a volute, turbinate, or spiral manner such that the sets or arrays of features do not intersect, but can be seen to generally spiral into a common center point centered upon the co-axial center of the brake rotor system as a whole. This volute arrangement of the elements is true for the pairs of rotor attachment holes 162, two of which are used on each rotor 106, 120 to attach a spacer 124 therebetween with the threaded pins 122 as described above. Similarly, between each set of rotor attachment holes 162, an inscribed slot 190 may be flanked on either side by a sequential series of venting holes 160. Consequently, adjacent to each pair of rotor attachment holes 162, a series of several venting holes 160 may flank each pair of rotor attachment holes. Between each set of venting holes 160, an inscribed slot 190 may be present.

The number of venting holes 160 in each series may generally be of any number as long as the physical integrity of the corresponding rotor is not affected so that rotor can withstand the stresses (both thermal and physical) arising from braking events.

As shown in FIG. 3, each of the several inscribed elements generally travels from the outer perimeter of the rotor 120 to the inner perimeter in a counterclockwise fashion. It is also possible for these inscribed elements to be inscribed in a clockwise manner. As rotational motion of the rotors 106, 120 tend to promote the outward travel of any object not attached to the rotor, such as air immediately surrounding the rotors and brake pad dust, it is seen as more efficient to arrange the inscribed elements in a manner where the leading edge is at the inner perimeter of the rotor and the trailing edge is at the outer end of the rotor. This can be seen with respect to the inscribed slots which have a leading edge 192 at a position further counterclockwise from the trailing edge 194.

If a particle of brake pad dust arises near the leading edge 192 of the inscribed slot 190 it will generally have a certain forward momentum imparted to it by the circular and rotational travel of the outer rotor 120 or inner rotor 106. As that brake dust particle travels forward, it travels outwardly towards the outer perimeter of the associated rotor as there is no retaining force to hold it in circular motion with respect to the rotor. Consequently, should the particle of brake pad dust travel along the inscribed slot 190, as the rotor turns, the forward travel of the particle of brake pad dust may coincide or otherwise be limited or aided by the inscribed channel 190. Upon reaching the terminal and trailing edge 194 of the inscribed slot 190, the particle of brake pad dust may leave the area adjacent the brake pad rotor system 100 and fall to the wayside.

Likewise, for the venting holes 160, the travel of air adjacent the outer surface of the outer rotor is generally not retained by any centripetal force and so if urged or forced forward by the turning of the rotor 120, such air will generally continue to travel in that direction, traveling from the inner perimeter of the rotor to its outer perimeter. If the rotor were static, this travel would generally be see as a straight line originating from the point of impact or contact and traveling straight across the face of the rotor in the direction of the rotor's turning. However, as the rotor itself is turning, the projection of the particle or other items path may be seen as being somewhat similar to the volute or arcuate path traveled by the inscribed slot 190 and the other parallel inscribed structures (venting holes 160 and rotor attachment holes 162) present in the inner and outer rotors 106, 120.

In combination with the air-propelling spacers 124 which generally act as propeller vanes to propel air between the inner and outer rotors 106, 120, a significant amount of air can be used as a cooling medium for the air-cooled brake rotor system 100 of the present invention. The disposition of the individual spacers 124 is such that as a brake pad or caliber system comes into contact with the brake rotor system 100, there is always some part of some spacer 124 present beneath the points of contact of the brake pads. This gives mechanical support to both of the inner and outer rotors 106, 120 and further provides for better operation and functioning of the brake rotor system 100.

FIG. 4 shows the inner surface of the inner rotor 106 with its rotor extensions 108, such extensions being absent from the outer rotor 120 (FIG. 3). No inscribing slots 190 are shown on the inner face of the inner rotor 106. The inner face of the inner rotor is similar or the same as that of the outer rotor 120 but in general in the form of a mirror image thereof. Inner surfaces of the inner and outer rotors 106, 120 are generally flat and smooth to engage the flat and smooth top and bottom spacer sides 150, 152 to provide as much physical engagement between the opposing flat surfaces as possible. Due to this close contact, the spacers 124 may serve to sink some of the heat away from the rotors 106, 120.

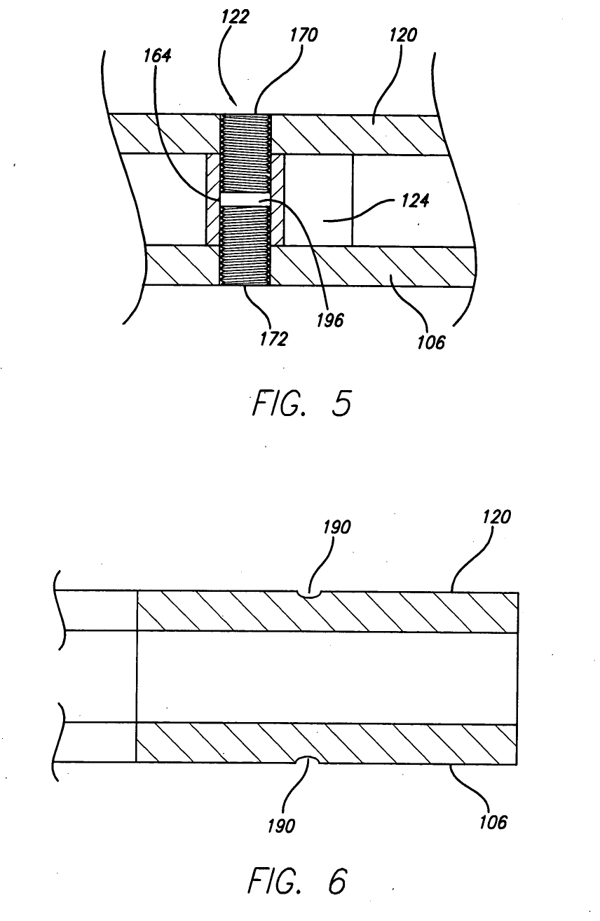

FIGS. 5 and 6 show cross-sections of particular elements of the brake rotor system 100. In FIG. 5, the threaded cross pin 122 is shown as threaded into the inner and outer rotors plates 106, 120. The top end 170 of the threaded pin 122 is threaded in one direction while the bottom end 172 is threaded in the opposite direction. As mentioned above, this ensures that by turning the threaded pin 122 in one direction, both the inner and outer rotor plates 106, 120 are drawn towards the center 196 of the threaded pin. Such travel of the inner and outer rotor plates 106, 120 is stopped by the spacer 124 and when the threaded pin 122 is turned as tightly as possible, the inner and outer rotor plates 106, 120 compress the spacer 124 therebetween. By both the frictional fit arising therefrom as well as the cutting off and smoothing down of any extending ends of the threaded pin 122, the threaded pin 122 is generally locked in place with respect to the inner and outer rotor plates 106, 120. Such locking of the threaded pin 122 may also occur due to the deformation of the threading at the terminal ends of the top and bottom 170, 172 of the threaded pin 122 that occurs during the cutting and smoothing process.

FIG. 6 shows a side cross-sectional view of the inscribed slots 190 as taken along line 6-6 of FIG. 1. As can be seen in FIG. 6, the inscribed slots, as is generally true for the inscribed elements for the inner and outer rotor 106, 120, are oppositely opposed to one another.

As mentioned above, the slot 198 defined between the inner and outer rotor plates 106, 120 has its inner perimeter generally free from the hub 102 due to the downwardly projecting extensions of the hub extensions 104. Consequently, the hub 102 generally does not restrict the free flow of air through the inter-rotor slot 198 and to complement this, the inner spacer ends 140 are generally aligned to the outer ends 142 of the hub extensions 104.

When the brake rotor system 100 is fixed to an axle and put into use, the turning of the brake rotor system causes the spacers 124 to propel air through the inter-rotor space 198. Due to the leading inner spacer ends 140 being forward of (with respect to the direction of circular travel of the brake rotor system 100) the trailing outer ends 146 of the spacers 124, air is propelled through the inner rotor slot and a greater volume of air is available for cooling the brake rotor system 100 as a whole. This cooling is complemented by the venting holes 160 which further promote air travel around and through the inner and outer brake rotor plates 106, 120.

The arcuate nature of the spacer geometry may also help to prevent rotor warping and generally induces solid contact with the brake rotor system when intense braking is needed.

The inner and outer rotor plates 106, 120 are generally made out of solid steel plate as plates that are made out of cast steel, cast aluminum, and some other materials are subject to cracking, causing failure of the air-cooled brake rotor system 100. The four-piece air-cooled brake rotor system 100 has a dynamic appearance as well as having a 100% bolt-on design. As set forth herein, the air-cooled brake rotor system may be lighter than original equipment manufacturer's (OEM) rotor systems and is generally fully compatible with anti-lock braking systems (ABS) of most original equipment manufacturers.

The rotors may be plated to prevent rust and the large rotor vanes, or spacers 124 allow for free air flow. Among the performance characteristics of the air-cooled brake rotor system 100 are that it has a generally solid stop-after-stop repeatability with respect to braking as well as having a solid steel design. Additionally, the air-cooled rotor system 100 provides good performance without compromising appearance and generally reduces heat that is sustained by the brake rotor system. The spacers 124 provide for faster free air flow and the solid plated steel nature of in one embodiment of the inner-and outer rotors 106, 120 generally prevents rust and generally ensures that the rotors will not crack under most, if not all, conditions. This is contrast to rotors that are cast. The rotors 106, 120 are cross-drilled and slotted to help prolong brake pad fade.

Using a solid steel plate, each rotor may be machined by a computer numeric controlled (CNC) machine techniques or otherwise. The use of solid plate steel generally ensures that the rotors will not crack when drilled.

In one embodiment, the plates are drilled with vent holes 160 that are approximately 0.250 inches in diameter while the rotor attachment holes may be approximately 0.375 inches in diameter and drilled to have tapped opposite locking threads to generally prevent the rotor plates 106, 120 from becoming loose over time. The slots may be approximately 0.120 inches in diameter and are generally used for excavating brake dust from the brake pad surface. The spacers 124 generally act as fan or turbine blades and become air moving agents to vacuum or propel heated air that may be trapped within the heated rotors or may otherwise move air through the inter-rotor space 198 and/or move air ambient the brake rotor system 100.

In one embodiment, the air-cooled brake rotor system 100 starts with a solid steel plate that is machined by CNC processes or otherwise to provide an initial rotor blank. The plates are then drilled with the venting holes 160 and the rotor attachment holes 162. The rotor attachment holes 162 may have tapped locking threads that are threaded in opposite directions according to the rotor plate (inner or outer) to which they are drilled. The inscribed slots 190 are then cut into the surface of the rotor plate. The spacer may be cut as by CNC processes from solid billet aluminum. The spacer through-holes 164 are then drilled. The spacers are then machined to generally maintain a flatness within 0.001 inches.

The threaded pins 122 may be manufactured on site or other-wise obtained. Generally, the threaded pins are machined with one end having a right hand thread-and the opposite end having a left hand thread. All of the elements in the air-cooled brake rotor system 100 may be plated to prevent rust and corrosion.

The pieces are then assembled together so that the two steel rotor plates 106, 120 are locked together by the threaded pins 122 with the spacers 124 in the middle. In a finishing step, both sides of the plates are cut to ensure that each outer surface of the plate is flat. Additionally, the inner surface of the rotor plates 106, 120 are machined so that they are also flat within the same tolerances desired for the spacers 124.

While the present invention has been described with regards to particular embodiments, it is recognized that additional variations of the present invention may be devised without departing from the inventive concept. Such variations may include different connecting elements for use as the threaded hub members 110 and/or the threaded pins 122 which may take a variety of threaded or other forms so long as the threaded hub members 110 securely attach the inner rotor 406 to the hub 102 and so that the threaded pin 122 securely fastens the inner and outer rotors 106, 120 together.

Further variations include the spacers 124 having an external geometry such that not only is air urged and/or propelled radially from the center outwards, but also laterally such that air is drawn across the rotors 106, 120. If the forward and trailing spacer surfaces 154, 156 are appropriately constructed, lateral force in a direction across the rotors 106, 120, in a direction at an angle off and/or oblique to the radial direction of the rotor system 100, and in a direction-generally similar to or in the direction of the central axis (FIG. 2) of the brake rotor system 100 may be achieved and imparted to adjacent air.

Similarly, the interior surfaces of the rotor plates 106, 120 may be shaped to complement the air-transporting action of the spacers 124 or to independently move air past, across, around, and/or through the rotors 106, 124. For example, the interior surfaces of the rotors 106, 120 may be shaped, scalloped, or otherwise configured to push (with pressure) or pull (with vacuum) air past, across, around, and/or through the braking system 100 and/or the rotors 106, 120.

What is claimed is:

1. A brake rotor, comprising:
a hub;
an inner rotor coupled to said hub;
an outer rotor coupled to said inner rotor; and
a spacer separating said inner rotor from said outer rotor.

2. A brake rotor as set forth in claim 1, further comprising:
said hub having a first radial extension for coupling said inner rotor to said hub.

3. A brake rotor as set forth in claim 1, further comprising:
said inner rotor detachably attached to said hub.

4. A brake rotor as set forth in claim 3, further comprising:
said inner rotor having a second radial extension for coupling said inner rotor to said hub.

5. A brake rotor as set forth in claim 3, further comprising:
said inner rotor defining a first vent hole allowing fluid flow through said first vent hole; and
said inner rotor defining a first slot inscribed on an outer surface of said inner rotor, said first slot channeling and urging debris away from said inner rotor.

6. A brake rotor as set forth in claim 3, further comprising:
said inner rotor defining a first threaded attachment hole for threadably coupling said outer rotor to said inner rotor, said first threaded attachment hole threaded in a first direction.

7. A brake rotor as set forth in claim 1, further comprising:
said outer rotor initially attached to said inner rotor in a detachably attached manner.

8. A brake rotor as set forth in claim 7, further comprising:
said outer rotor having an inner diameter engaging an outer surface of said hub.

9. A brake rotor as set forth in claim 7, further comprising:
said outer rotor defining a second vent hole allowing fluid flow through said second vent hole; and
said outer rotor defining a second slot inscribed on an outer surface of said outer rotor, said second slot channeling and urging debris away from said outer rotor.

10. A brake rotor as set forth in claim 7, further comprising:
said outer rotor defining a second threaded attachment hole for threadably coupling said outer rotor to said inner rotor, said second threaded attachment hole threaded in a second direction.

11. A brake rotor as set forth in claim 1, further comprising:
said spacer shaped to act as a turbine vane whereby air is driven through a space defined between said inner and outer rotors when the brake rotor turns.

12. A brake rotor as set forth in claim 11, further comprising:
said spacer initially coupled to said inner and outer rotors in a detachably attached manner.

13. A brake rotor as set forth in claim 11, further comprising:
said spacer coupled to said inner and outer rotors in an oblique manner relative to a radius of said inner and outer rotors.

14. A brake rotor as set forth in claim 1, further comprising:
a threaded pin coupling said inner rotor to said outer rotor, said threaded pin passing through a spacer hole defined in said spacer.

15. A brake rotor as set forth in claim 14, further comprising:
said threaded pin having first and second opposite ends; and
said first end being threaded in a first direction and said second end being threaded in a second direction.

16. A brake rotor as set forth in claim 15, further comprising:
said inner rotor defining a first threaded hole threaded in said first direction;
said first end of said threaded pin engaging said first threaded hole;
said outer rotor defining a second threaded hole threaded in said second direction;
said second end of said threaded pin engaging said second threaded hole; and
said first and second directions being such that turning said threaded pin in a first circular direction urges said inner and outer rotors together and turning said threaded pin in a second circular direction urges said inner and outer rotors apart.

17. A brake rotor as set forth in claim 14, further comprising:
said threaded pin being of material softer than said inner rotor and said outer rotor.

18. A brake rotor, comprising:
a hub, said hub having a first radial extension having an outer surface;
an inner rotor detachably coupled to said hub, said inner rotor having a second radial extension for detachably coupling said inner rotor to said first radial extension of said hub;
said inner rotor defining a first vent hole allowing fluid flow through said first vent hole, said inner rotor defining a first slot inscribed on an outer surface of said inner rotor, said first slot channeling and urging debris away from said inner rotor, said inner rotor defining a first threaded attachment hole for threadably coupling said outer rotor to said inner rotor, said first threaded attachment hole threaded in a first threaded direction;
an outer rotor coupled to said inner rotor, said outer rotor initially attached to said inner rotor in a detachably attached manner, said outer rotor having an inner diameter engaging said outer surface of said first radial extension of said hub;
said outer rotor defining a second vent hole allowing fluid flow through said second vent hole, said outer rotor defining a second slot inscribed on an outer surface of said outer rotor, said second slot channeling and urging debris away from said outer rotor, said outer rotor defining a second threaded attachment hole for threadably coupling said outer rotor to said inner rotor, said second threaded attachment hole threaded in a second threaded direction;
said first vent hole, said first slot, and said first threaded attachment hole of said inner rotor oppositely opposed said second vent hole, said second slot, and said second threaded attachment hole of said outer rotor;
a spacer separating said inner rotor from said outer rotor, said spacer shaped to act as a turbine vane whereby air is driven through a space defmed between said inner and outer rotors when the brake rotor turns, said spacer defining a spacer hole, said spacer coupled in an oblique manner to said inner and outer rotors in an initially detachably attached manner; and
a threaded pin coupling said inner rotor to said outer rotor, said threaded pin being softer than said inner rotor and said outer rotor, said threaded pin passing through said spacer hole, said threaded pin having first and second opposite ends, said first end being threaded in said first threaded direction and said second end being threaded in said second threaded direction;
said first end of said threaded pin engaging said first threaded attachment hole and said second end of said threaded pin engaging said second threaded attachment hole; and
said first and second threaded directions being such that turning said threaded pin in a first circular direction urges said inner and outer rotors together and turning said threaded pin in a second circular direction urges said inner and outer rotors apart.

19. A braking disk system in a brake rotor system having a hub, the braking disk system comprising:
an inner rotor;
an outer rotor coupled to said inner rotor; and
a spacer separating said inner rotor from said outer rotor.

20. A braking disk system as set forth in claim 19, further comprising:
said inner rotor adapted for detachably attachment to the hub.

21. A braking disk system as set forth in claim 20, further comprising:
said inner rotor having a first radial extension for coupling said inner rotor to the hub.

22. A braking disk system as set forth in claim 20, further comprising:
said inner rotor defining a first vent hole allowing fluid flow through said first vent hole; and
said inner rotor defining a first slot inscribed on an outer surface of said inner rotor, said first slot channeling and urging debris away from said inner rotor.

23. A braking disk system as set forth in claim 20, further comprising:
said inner rotor defining a first threaded attachment hole for threadably coupling said outer rotor to said inner rotor, said first threaded attachment hole threaded in a first direction.

24. A braking disk system as set forth in claim 19, further comprising:
said outer rotor initially attached to said inner rotor in a detachably attached manner.

25. A braking disk system as set forth in claim 24, further comprising:
said outer rotor having an inner diameter engaging an outer surface of the hub.

26. A braking disk system as set forth in claim 24, further comprising:
said outer rotor defining a second vent hole allowing fluid flow through said second vent hole; and
said outer rotor defining a second slot inscribed on an outer surface of said outer rotor, said second slot channeling and urging debris away from said outer rotor.

27. A braking disk system as set forth in claim 24, further comprising:
said outer rotor defining a second threaded attachment hole for threadably coupling said outer rotor to said inner rotor, said second threaded attachment hole threaded in a second direction.

28. A braking disk system as set forth in claim 19, further comprising:
said spacer shaped to act as a turbine vane whereby air is driven through a space defined between said inner and outer rotors when the brake rotor turns.

29. A braking disk system as set forth in claim 28, further comprising:
said spacer initially coupled to said inner and outer rotors in a detachably attached manner.

30. A braking disk system as set forth in claim 28, further comprising:
said spacer coupled to said inner and outer rotors in an oblique manner relative to a radius of said inner and outer rotors.

31. A braking disk system as set forth in claim 19, further comprising:
a threaded pin coupling said inner rotor to said outer rotor, said threaded pin passing through a spacer hole defined in said spacer.

32. A braking disk system as set forth in claim 31, further comprising:
said threaded pin having first and second opposite ends; and
said first end being threaded in a first direction and said second end being threaded in a second direction.

33. A braking disk system as set forth in claim 32, further comprising:
said inner rotor defining a first threaded hole threaded in said first direction;
said first end of said threaded pin engaging said first threaded hole;
said outer rotor defining a second threaded hole threaded in said second direction;
said second end of said threaded pin engaging said second threaded hole; and
said first and second directions being such that turning said threaded pin in a first circular direction urges said inner and outer rotors together and turning said threaded pin in a second circular direction urges said inner and outer rotors apart.

34. A braking disk system as set forth in claim 31, further comprising:
said threaded pin being of material softer than said inner rotor and said outer rotor.

35. A braking disk system in a brake rotor system having a hub, the braking disk system comprising:
an inner rotor adapted to detachably attach to the hub, said inner rotor having a first radial extension for detachably coupling said inner rotor to the hub;
said inner rotor defining a first vent hole allowing fluid flow through said first vent hole, said inner rotor defining a first slot inscribed on an outer surface of said inner rotor, said first slot channeling and urging debris away from said inner rotor, said inner rotor defining a first threaded attachment hole for threadably coupling said outer rotor to said inner rotor, said first threaded attachment hole threaded in a first threaded direction;
an outer rotor coupled to said inner rotor, said outer rotor initially attached to said inner rotor in a detachably attached manner, said outer rotor having an inner diameter engaging an outer surface of the hub;
said outer rotor defining a second vent hole allowing fluid flow through said second vent hole, said outer rotor defining a second slot inscribed on an outer surface of said outer rotor, said second slot channeling and urging debris away from said outer rotor, said outer rotor defining a second threaded attachment hole for threadably coupling said outer rotor to said inner rotor, said second threaded attachment hole threaded in a second threaded direction;
said first vent hole, said first slot, and said first threaded attachment hole of said inner rotor oppositely opposed said second vent hole, said second slot, and said second threaded attachment hole of said outer rotor;
a spacer separating said inner rotor from said outer rotor, said spacer shaped to act as a turbine vane whereby air is driven through a space defined between said inner and outer rotors when the brake rotor turns, said spacer defining a spacer hole, said spacer coupled in an oblique manner to said inner and outer rotors in an initially detachably attached manner; and
a threaded pin coupling said inner rotor to said outer rotor, said threaded pin being softer than said inner rotor and said outer rotor, said threaded pin passing through said spacer hole, said threaded pin having first and second opposite ends, said first end being threaded in said first threaded direction and said second end being threaded in said second threaded direction;
said first end of said threaded pin engaging said first threaded attachment hole and said second end of said threaded pin engaging said second threaded attachment hole; and
said first and second threaded directions being such that turning said threaded pin in a first circular direction urges said inner and outer rotors together and turning said threaded pin in a second circular direction urges said inner and outer rotors apart.

36. A brake rotor disk for a brake rotor system having a hub, the brake rotor disk comprising:
a braking disk adapted for coupling to the hub;
said braking disk defining a first vent hole allowing fluid flow through said first vent hole;
said braking disk defining a first slot inscribed on an outer surface of said braking disk;
said first slot channeling and urging debris away from said braking disk;
said braking disk defining a first threaded attachment hole, said first threaded attachment hole threaded in a first threaded direction and adapted for receiving a threaded pin.

37. A brake rotor disk for a brake rotor system as set forth in claim 36, further comprising:
said first vent hole being one in a series of vent holes in a first set of vent holes;
said first set of vent holes generally arranged in a serial fashion along a radius of curvature at an oblique angle to a radius of said braking disk;
said first slot proximate said first set of vent holes, said first slot being generally parallel to said first set of vent holes;
a second set of vent holes generally arranged in a serial fashion proximate said first slot, said second set of vent holes being generally parallel to said first set of vent holes;
said first threaded attachment hole being one in a series of threaded attachment holes in a first set of threaded attachment holes; and
said first set of threaded attachment holes arranged in a serial fashion proximate said second set of vent holes and being generally parallel to said first set of vent holes.

38. A brake rotor disk for a brake rotor system as set forth in claim 37, further comprising:
said first set of vent holes having four vent holes;
said second set of vent holes having four vent holes; and
said first set of threaded attachment holes having two threaded attachment holes.

39. A brake rotor disk for a brake rotor system as set forth in claim 37, further comprising:
a feature pattern comprising said first set of vent holes, said first slot, said second set of vent holes, and said first threaded attachment hole, said feature pattern being repeated in periodic fashion about a perimeter of the brake rotor disk.

40. A spacer for a brake rotor system having two oppositely opposed coaxial brake rotor disks, the spacer comprising:
an arcuate parallelepiped of resilient material having two generally flat sides adapted for engagement with interior surfaces of the brake rotor disks at an oblique angle with respect to a radius of the brake rotor disks;
said arcuate parallelepiped having a top side, a bottom side, a front side, and a rear side;
said top side curved to conform with an outer perimeter of the brake rotor disks; and
said bottom side curved to conform with an inner perimeter of the brake rotor disks.

41. A spacer for a brake rotor system having two oppositely opposed coaxial brake rotor disks as set forth in claim 40, further the spacer comprising:
said front side curved to propel air between the brake rotor disks; and
said rear side curved to enable air travel between the brake rotors.

42. A method of making a braking disk system in a brake rotor system having a hub, the steps comprising:
providing a first annular braking plate;
forming a first air vent hole in said first annular braking plate;
inscribing a first slot on an outer surface of said first annular braking plate; and
forming a first threaded attachment hole in said first annular braking plate, said first threaded attachment hole threaded in a first direction.

43. A method of making a braking disk system in a brake rotor system having a hub as set forth in claim 42, further comprising:
said first vent hole being one in a series of vent holes in a first set of vent holes;
said first set of vent holes generally arranged in a serial fashion along a radius of curvature at an oblique angle to a radius of said braking disk;
said first slot proximate said first set of vent holes, said first slot being generally parallel to said first set of vent holes;
forming a second air vent hole in said first annular braking plate, said second vent hole being one in a series of vent holes in a second set of vent holes;
said second set of vent holes generally arranged in a serial fashion proximate said first slot, said second set of vent holes being generally parallel to said first set of vent holes;
said first threaded attachment hole being one in a series of threaded attachment holes in a first set of threaded attachment holes; and
said first set of threaded attachment holes arranged in a serial fashion proximate said second set of vent holes and being generally parallel to said first set of vent holes.

44. A method of making a braking disk system in a brake rotor system having a hub as set forth in claim 42, further comprising:
providing a second annular braking plate;
forming a third air vent hole in said second annular braking plate;
inscribing a second slot on an outer surface of said second annular braking plate; and
forming a second threaded attachment hole in said second annular braking plate, said second threaded attachment hole threaded in a second direction.

45. A method of making a braking disk system in a brake rotor system having a hub as set forth in claim 44, further comprising:
providing a spacer; and
providing a threaded pin,
coupling said first annular braking plate to second annular braking plate by said threaded pin, said threaded pin passing through a spacer hole defined in said spacer.

46. A method of making a braking disk system in a brake rotor system having a hub as set forth in claim 45, further comprising:
said threaded pin having first and second opposite ends; and
said first end being threaded in said first direction and said second end being threaded in said second direction.

47. A method of making a braking disk system in a brake rotor system having a hub as set forth in claim 46, wherein the step of coupling said first and second annular braking plates further comprises:
engaging said first threaded attachment hole with said first end of said threaded pin;
engaging said second threaded attachment hole with said second end of said threaded pin;
said first and second directions being such that turning said threaded pin in a first circular direction urges said first and second annular braking plates together and turning said threaded pin in a second circular direction urges said first and second annular braking plates apart; and
turning said threaded pin to bring said first and second annular braking plates together to compressibly engage said spacer.

48. A method of making a braking disk system in a brake rotor system having a hub as set forth in claim 45, further comprising:
said threaded pin being of material softer than said first and second annular braking plates.

49. A method of making a braking disk system in a brake rotor system having a hub, the steps comprising
providing a first annular braking plate;
forming a first set of vent holes in said first annular braking plate, said first set of vent holes generally arranged in a serial fashion along a radius of curvature at an oblique angle to a radius-of said braking disk;
inscribing a first slot on an outer surface of said first annular braking plate, said first slot proximate said first set of vent holes, said first slot being generally parallel to said first set of vent holes;
forming a second set of vent holes in said first annular braking plate, said second set of vent holes generally arranged in a serial fashion proximate said first slot, said second set of vent holes being generally parallel to said first set of vent holes;
forming a first set of threaded attachment holes in said first annular braking plate, each threaded attachment hole in said first set of threaded attachment holes being threaded in a first direction, said first set of threaded attachment holes arranged in a serial fashion proximate said second set of vent holes and being generally parallel to said first set of vent holes;
providing a second annular braking plate;
forming a third set of vent holes in said second annular braking plate, said third set of vent holes generally arranged in a serial fashion along a radius of curvature at an oblique angle to a radius of said braking disk;
inscribing a second slot on an outer surface of said second annular braking plate, said second slot proximate said third set of vent holes, said second slot being generally parallel to said third set of vent holes;
forming a fourth set of vent holes in said second annular braking plate, said fourth set of vent holes generally arranged in a serial fashion proximate said first slot, said fourth set of vent holes being generally parallel to said third set of vent holes;
forming a second set of threaded attachment holes in said second annular braking plate, each threaded attachment hole in said second set of threaded attachment holes being threaded in a second direction, said second set of threaded attachment holes arranged in a serial fashion proximate said fourth set of vent holes and being generally parallel to said third set of vent holes;
providing a spacer;
providing a threaded pin, said threaded pin being of material softer than said first and second annular braking plates, said threaded pin having first and second opposite ends, said first end being threaded in said first direction and said second end being threaded in said second direction, said threaded pin passing through a spacer hole defined in said spacer; and
coupling said first annular braking plate to second annular braking plate by said threaded pin by engaging said first threaded attachment hole with said first end of said threaded pin, engaging said second threaded attachment hole with said second end of said threaded pin, said first and second directions being such that turning said threaded pin in a first circular direction urges said first and second annular braking plates together and turning said threaded pin in a second circular direction urges said first and second annular braking plates apart, and turning said threaded pin to bring said first and second annular braking plates together to compressibly engage said spacer.
